(19) United States
(12) Patent Application Publication
(10) Pub. No.: US 2008/0211202 A1
(43) Pub. Date: Sep. 4, 2008

(54) Stabilizer Link Assembly

(76) Inventors: John Belding, Brewer, ME (US); Greg Dambois, Brewer, ME (US); Daniel Dearing, Plymouth, MI (US); Jeremy R. King, Duncan, SC (US); Keith Kinney, Brewer, ME (US); Mark Kittridge, Orono, ME (US); Brian Perkins, Orrington, ME (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/915,219

(22) PCT Filed: May 23, 2005
(86) PCT No.: PCT/US2006/019918

§ 371 Date: Mar. 10, 2008

Related U.S. Application Data
(60) Provisional application No. 60/683,679, filed on May 23, 2005.

(51) Int. Cl. B60G 21/055; B22D 19/04

(52) U.S. Cl. 280/124.107; 29/525.14; 164/91

(57) ABSTRACT

A stabilizer link assembly formed by die casting end rings over the ends of a stabilizer link rod.

### RELATED APPLICATION

This application claims priority of U.S. Provisional Patent Application Ser. No. 60/683,679 filed May 23, 2005, which is incorporated herein by reference.

### FIELD OF THE INVENTION

The present invention relates to a stabilizer link assembly for vehicles and more particularly to a means of mounting the end rings to a stabilizer link rod.

### BACKGROUND OF THE INVENTION

A stabilizer link assembly for vehicles commonly comprises a stabilizer link rod having an end ring mounted at each end of the rod. A common way of joining the rings to the rod is to weld the pieces together before mounting the couplings in place within the ring to form the completed assembly.

### SUMMARY OF THE INVENTION

The present invention relates to a vehicle stabilizer link assembly and more particularly to a vehicle stabilizer link assembly which includes a stabilizer link rod and an end ring at each end of the stabilizer rod. The end rings are formed by die casting them directly onto each end of the stabilizer link rod. This eliminates the operation of welding.

### BRIEF DESCRIPTION OF THE DRAWING

A better understanding of the present invention can be understood by reference to the following drawings illustrating a stabilizer link assembly formed in accordance with the present invention and in which:

FIG. 1 is an elevational view of a stabilizer link rod assembly formed in accordance with the method of the present invention;

FIG. 2 is an enlarged fragmentary view of a portion of the stabilizer link assembly shown in FIG. 1;

FIG. 3 is a fragmentary elevational view of a stabilizer link assembly which includes a coupling mounted to the end ring; and

FIG. 4 is a cross sectional view taken substantially at line 4-4 of Figure. illustrating the manner of molding the end ring to one end of the stabilizer rod.

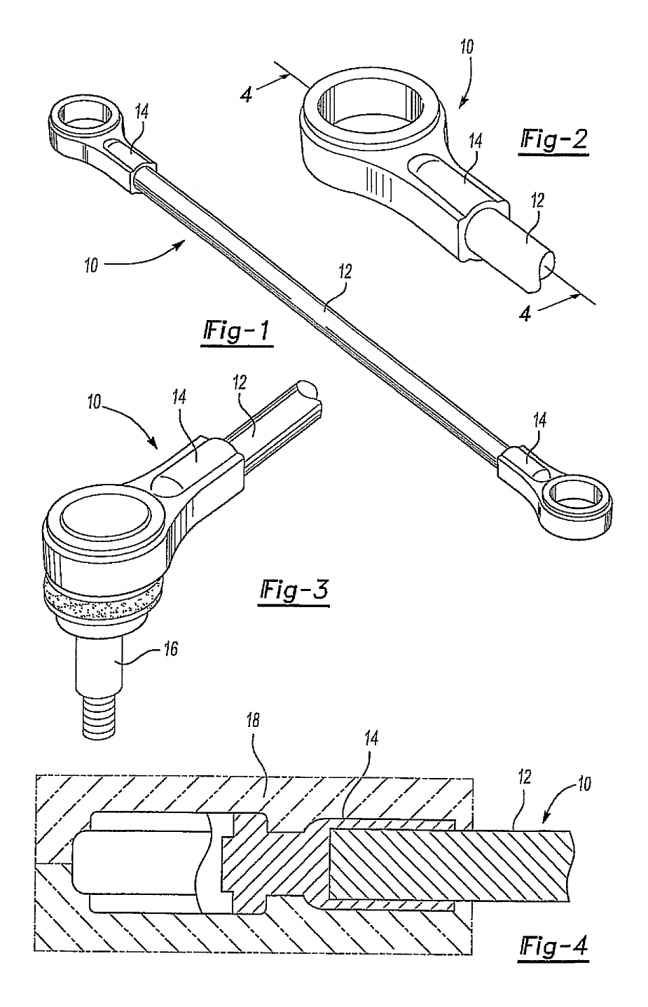

### DETAILED DESCRIPTION OF THE INVENTION

Referring to the drawings, a stabilizer link assembly is illustrated at 10 and comprises a stabilizer link rod 12 and an end ring 14 formed at each end of the stabilizer link rod 12. The end rings 14 provide the means for connecting the stabilizer link rod 12 to the other elements such as the coupling 16 (FIG. 3) in the steering assembly for a vehicle.

Heretofore the end rings 14 have commonly been mounted to the ends of the rod 12 by welding or the like. The process of the present invention comprises die casting the end rings 14 directly over an end of the stabilizer link rod 12. This is best illustrated in FIG. 4 in which a mold 18 is shown in phantom and the end ring 14 is being cast about one end of the stabilizer rod 12. The end rings 14 are preferably formed of a moldable metal such as zinc, aluminum or magnesium.

This process of die casting the end rings 14 onto the ends of the stabilizer link rod 12 has reduced material costs over those of the welding process by approximately 20%. Further, pre-plated stabilizer link rods 12 can be used resulting in savings on inventory and shipping. Also, the die casting employed to form the end rings 14 over the ends of the stabilizer link rod 12 can be highly automated.

It is apparent that although a specific combination of end rings and rods have been disclosed and described, the present invention could include members other than the end rings 14 mounted by casting to the stabilizer link rod 12.

We claim:

1. A stabilizer link assembly comprising a stabilizer link rod and an end ring mounted to the end of said rod by casting the ring around the end of the rod.

2. A method of forming a stabilizer link assembly comprising the steps of:
a) pre-forming an elongated stabilizer link rod;
b) die casting an end ring to at least one end of said rod.

3. The method of claim 2 and in which said end ring is formed to provide a connection between said stabilizer link rod and other elements of said stabilizer link assembly.

4. The method of claim 2 and including the step of die casting an end ring member at the other end of said rod.

5. The method of claim 2 and in which said end ring is formed of a material from the set of zinc, aluminum or magnesium.

6. A method of forming a stabilizer link assembly comprising the steps of:
a) pre-forming an elongated stabilizer link rod;
b) providing a mold with a cavity in the shape of an end ring and positioning the mold over one end of the stabilizer link rod and
d) introducing molten metal into said mold to die cast an end ring to the one end of said rod.
